(19) United States
(12) Patent Application Publication
(10) Pub. No.: US 2017/0041448 A1
(43) Pub. Date: Feb. 9, 2017

(54) REMOTE CONFIGURATION AND PRE-SETUP FOR LIMITED INPUT WEARABLE DEVICES

(71) Applicant: Intel Corporation, Santa Clara, CA (US)

(72) Inventors: Andy S. Idsinga, Portland, OR (US); Aaren B Esplin, Portland, OR (US); Gregory A. Peek, North Plains, OR (US); Jari Luoma-Aho, Tampere (FI)

(73) Assignee: Intel Corporation, Santa Clara, CA (US)

(21) Appl. No.: 15/296,362

(22) Filed: Oct. 18, 2016

Related U.S. Application Data
(62) Division of application No. 14/142,751, filed on Dec. 28, 2013, now abandoned.

(51) Int. Cl. H04M 1/725; H04W 4/00; H04W 8/20

(52) U.S. Cl. CPC H04M 1/72525; H04W 8/205; H04W 4/001

(57) ABSTRACT

Methods and apparatus relating to remote configuration and/or pre-setup for mobile devices are described. In an embodiment, logic causes receipt of user information at a device, which includes the logic, from a web portal in response to powering up the device. The logic causes creation of an account at the web portal for an end user in response to receipt of the user information and a code from the web portal at the logic. The logic causes display of the code to the end user to cause the device to become associated with the account in response to receipt of the code from the end user at the web portal. Other embodiments are also disclosed and claimed.

### FIELD

The present disclosure generally relates to the field of electronics. More particularly, an embodiment relates to techniques for remote configuration and/or pre-setup for mobile devices.

### BACKGROUND

Today, if a consumer buys a mobile device, the consumer (or another entity such as the seller) may need to upload or synchronize data from the old device or from some other source before the consumer can start using the new device. However, as mobile devices become more common-place, the user experience associated with initializing such devices for an end-user becomes of utmost importance.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1 and 7-9 illustrate block diagrams of embodiments of computing systems, which may be utilized to implement various embodiments discussed herein.

FIGS. 2-4 illustrate sequence diagrams describing data and authentication flows for a new device purchase, gifting a new device, and factory reset of a device, respectively, according to some embodiments.

FIGS. 5-6 illustrate sequence diagrams describing flows for a mobile device before purchase decision and during purchase transaction at store, respectively, according to some embodiments.

### DETAILED DESCRIPTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware, software, firmware, or some combination thereof.

Some embodiments provide techniques for remote configuration and/or pre-setup for mobile devices (including, for example, limited input wearable devices) to provide a personalized out-of-the box experience. For example, an embodiment provides a streamlined out-of-box experience for mobile devices such that when a consumer purchases a device over the web (or at a store), or receives the device as a gift, the device is personalized and ready to use when the user unboxes the mobile device and turns the device on. Furthermore, device configuration may be done through a web application/portal and cellular network to enhance ease of use for limited input devices. Hence, such techniques allow for a better user experience where potentially a cellular mobile device is available and/or when a device has limited user input facilities.

In one embodiment, part of a mobile SOC (System On Chip) DRAM (Dynamic Random Access Memory) may be augmented with or replaced by a Non-Volatile Memory (NVM), such as resistive random access memory, Phase Change Memory (PCM), Spin Torque Transfer Random Access Memory (STTRAM), 3D (3-Dimensional) Cross Point Memory, etc.) and a wireless interface is then used to program the NVM during a purchasing transaction, while the device is still inside the sales box. The data stored/transferred to the NVM may include any type of data, e.g., ranging from as simple as a user's name (e.g., displayed during first power-on after unboxing) to all or a portion of a user selected data (e.g., via a web service such as discussed herein) to transfer to the new device.

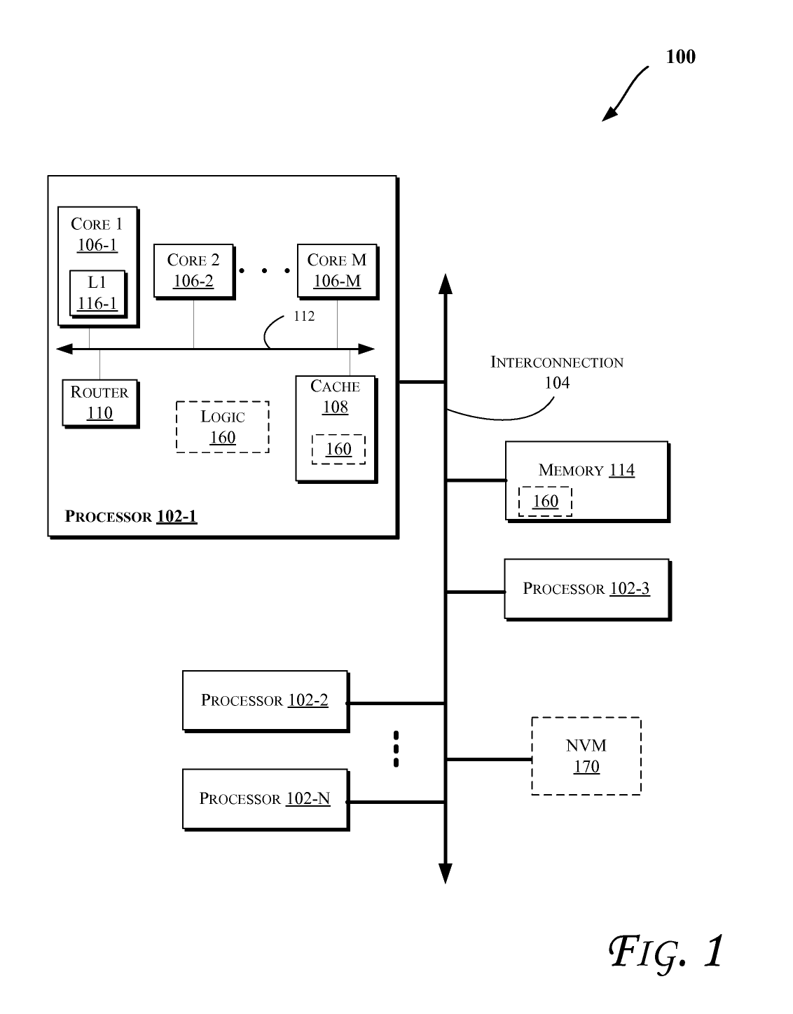

Some embodiments may be applied in computing systems that include one or more processors (e.g., with one or more processor cores), such as those discussed with reference to FIGS. 1-9, including for example mobile computing devices such as a smartphone, tablet, UMPC (Ultra-Mobile Personal Computer), laptop computer, Ultrabook™ computing device, smart watch, smart glasses, wearable devices, etc. More particularly, FIG. 1 illustrates a block diagram of a computing system 100, according to an embodiment. The system 100 may include one or more processors 102-1 through 102-N (generally referred to herein as “processors 102” or “processor 102”). The processors 102 may be general-purpose CPUs and/or GPUs in various embodiments. The processors 102 may communicate via an interconnection or bus 104. Each processor may include various components some of which are only discussed with reference to processor 102-1 for clarity. Accordingly, each of the remaining processors 102-2 through 102-N may include the same or similar components discussed with reference to the processor 102-1.

In an embodiment, the processor 102-1 may include one or more processor cores 106-1 through 106-M (referred to herein as “cores 106,” or “core 106”), a cache 108, and/or a router 110. The processor cores 106 may be implemented on a single integrated circuit (IC) chip. Moreover, the chip may include one or more shared and/or private caches (such as cache 108), buses or interconnections (such as a bus or interconnection 112), graphics and/or memory controllers (such as those discussed with reference to FIGS. 7-9), or other components.

In one embodiment, the router 110 may be used to communicate between various components of the processor 102-1 and/or system 100. Moreover, the processor 102-1 may include more than one router 110. Furthermore, the multitude of routers 110 may be in communication to enable data routing between various components inside or outside of the processor 102-1.

The cache 108 may store data (e.g., including instructions) that are utilized by one or more components of the processor 102-1, such as the cores 106. For example, the cache 108 may locally cache data stored in a memory 114 for faster access by the components of the processor 102 (e.g., faster access by cores 106). As shown in FIG. 1, the memory 114 may communicate with the processors 102 via the interconnection 104. In an embodiment, the cache 108 (that may be shared) may be a mid-level cache (MLC), a last level cache (LLC), etc. Also, each of the cores 106 may include a level 1 (L1) cache (116-1) (generally referred to herein as “L1 cache 116”) or other levels of cache such as a level 2 (L2) cache. Moreover, various components of the processor 102-1 may communicate with the cache 108 directly, through a bus (e.g., the bus 112), and/or a memory controller or hub.

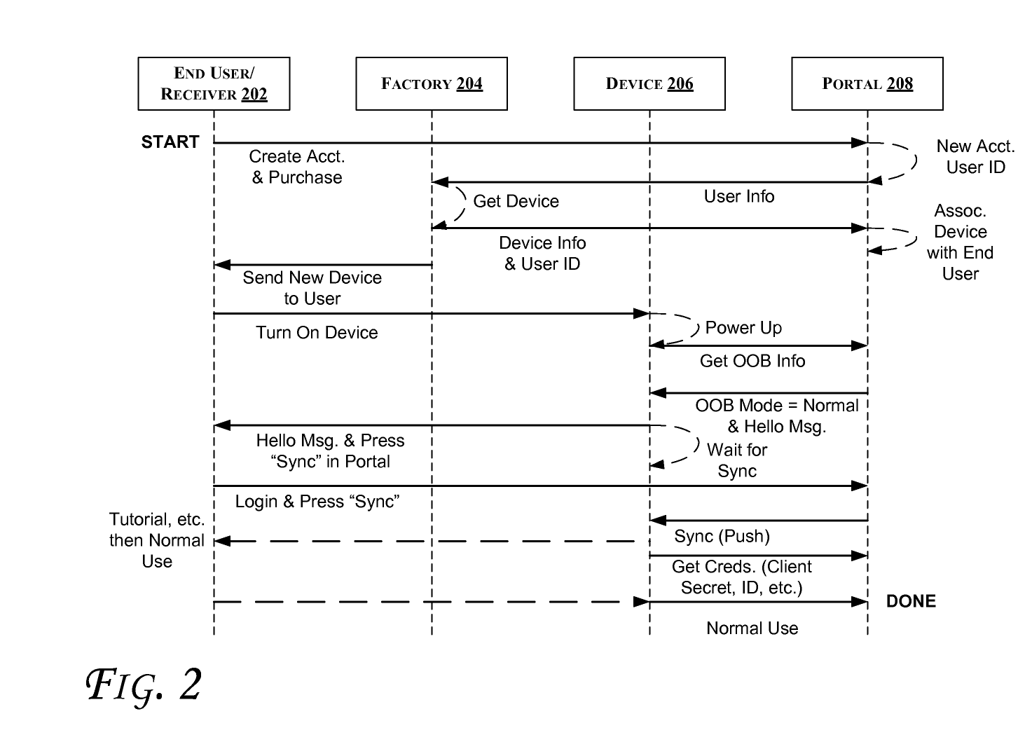

As shown in FIG. 1, the processor 102 may further include logic 160 to provide remote configuration and/or pre-setup for mobile devices (including, for example, limited input wearable devices) resulting in a personalized out-of-the box experience, as will be further discussed herein, e.g., with reference to FIGS. 2-9. While some potential locations for logic 160 is illustrate in FIG. 1, logic 160 may be provided in locations other than those shown. Moreover, logic 160 may be provided as software (e.g., stored in cache 108 and/or memory 114), firmware (e.g., stored in a non-volatile memory such as NVM 170 or as part of a Basic Input/Output System (BIOS) (not shown)), etc.

Also, NVM 170 may provide a storage device to store various types of data, e.g., to provide a personalized out-of-the box experience. NVM 170 may include any type of non-volatile or flash memory including, for example, resistive random access memory, Phase Change Memory (PCM), Spin Torque Transfer Random Access Memory (STTRAM), 3D (3-Dimensional) Cross Point Memory, etc. Furthermore, system 100 may include or have access to a network interface device capable of wireless communication (such as device 730 of FIG. 7, coupled to an antenna 731 to wirelessly (e.g., via an Institute of Electrical and Electronics Engineers (IEEE) 802.11 interface (including IEEE 802.11a/b/g/n, etc.), cellular interface, 3G, 5G, LTE (Long Term Evolution), etc.) communicate with a computer network such as network 703 discussed with reference to FIG. 7).

FIGS. 2-4 illustrate sequence diagrams describing data and authentication flows for a new device purchase, gifting a new device, and factory reset of a device, respectively, according to some embodiments. One or more components discussed herein (e.g., with reference to FIGS. 1 and 7-9) may be used to perform one or more operations discussed with reference to FIGS. 2-4. For example, logic 160 may be used to perform the operations discussed with reference to FIGS. 2-4 at the device and/or NVM 170 may be used to store information (such as unique identifier(s), authentication data, IDs, credentials, client/device secret keys, etc.). Also, the arrows in FIGS. 2-4 illustrate the data/operation flow direction (with the corresponding text appearing below arrows, with the exception of curved arrows that have their corresponding text next to the arrows).

More particularly, FIG. 2 shows the sequence for purchasing a new device by an end user 202. The sequence starts by the end user 202 creating an account and purchasing the device 206 from a factory/seller 204. The user account is generated at a portal 208 (which may be a web/network portal that allows the user 202 to input/select various account options). Once a new account/user identification (ID) is generated at portal 208, user information (such as user ID, etc.) is forwarded to the factory/seller 204 that obtains the device and associates the device with the end user via the portal. The seller/factory 204 then sends the new device to the user, who turns it on. During power up, the device 206 contacts the portal 208 (e.g., per the user info configuration performed at the factory) and obtains personalized OOB (Out Of Box) information from the portal 208. After the OOB information is obtained the device mode is set to “normal” and message (e.g., a hello message) is sent to the user to request that the user start the synchronization (e.g., in the portal) and the sequence then waits for the synchronization. Once the user initiates the synchronization process (e.g., logs in to the portal and/or presses a synchronization button), the device starts synchronizing with the portal information (e.g., by the portal pushing the synchronization information). The synchronization may also include or require various authentication operations (e.g., based on exchange/provision of authentication information such as credential information, client/device secret keys, biometric information (such as voice, pulse fingerprint, etc.), IDs, etc.). The end user then receives information (e.g., regarding a personalized tutorial on how to use the device, confirmation that the synchronization is done, etc.) and starts normal use of the device.

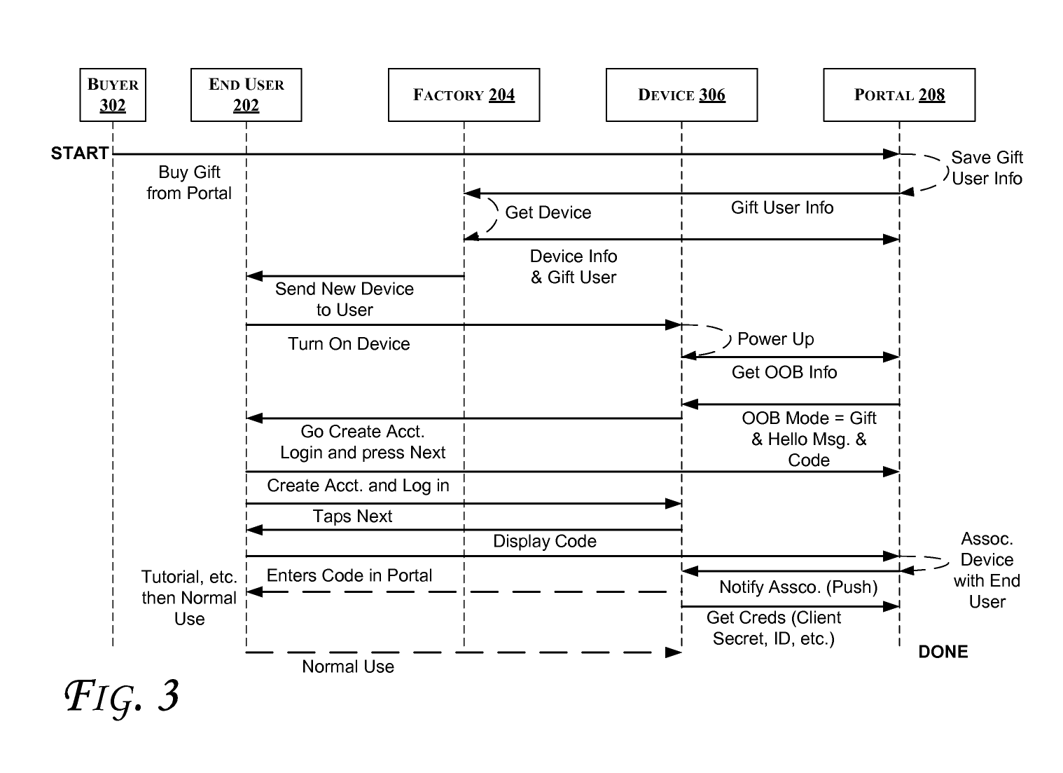

Referring to FIG. 3, the sequence for purchasing a new device as a gift is shown. The sequence starts by a buyer 302 purchasing a new device as a gift from the portal 208 for the end user 202. The portal saves the gift user info during the purchase process (e.g., including a gift message, shipping/user address, phone number, etc.). The gift user information is forwarded to the factory/seller 204 that obtains the device and sends the gift user and device information back to the portal so the portal associates the device with the user. The seller/factory 204 then sends the new device to the user, who turns it one. During power up, the device 206 contacts the portal 208 (e.g., per the user info configuration performed at the factory) and obtains OOB information from the portal 208. After the OOB information is obtained the device mode is set to “gift” and message (e.g., a personalized “hello” message or a personalized greeting message) and code is sent to the user to request that the user creates an account and logs into the portal to press “next”. In turn the user creates an account on the portal and logs in and then presses “next”. The device displays the code (that was sent by the portal when the mode was set to “gift”). The user enters the code in the portal which in turn authenticates the user and associates the device with the user. The association is then notified (e.g., pushed to the device). The user then receives information (e.g., regarding a personalized tutorial, etc.). Next, various authentication operations may be done (such as exchange of credential information, client/device secret keys, biometric information (such as voice, pulse fingerprint, etc.) IDs, etc.). The end user then starts normal use of the device.

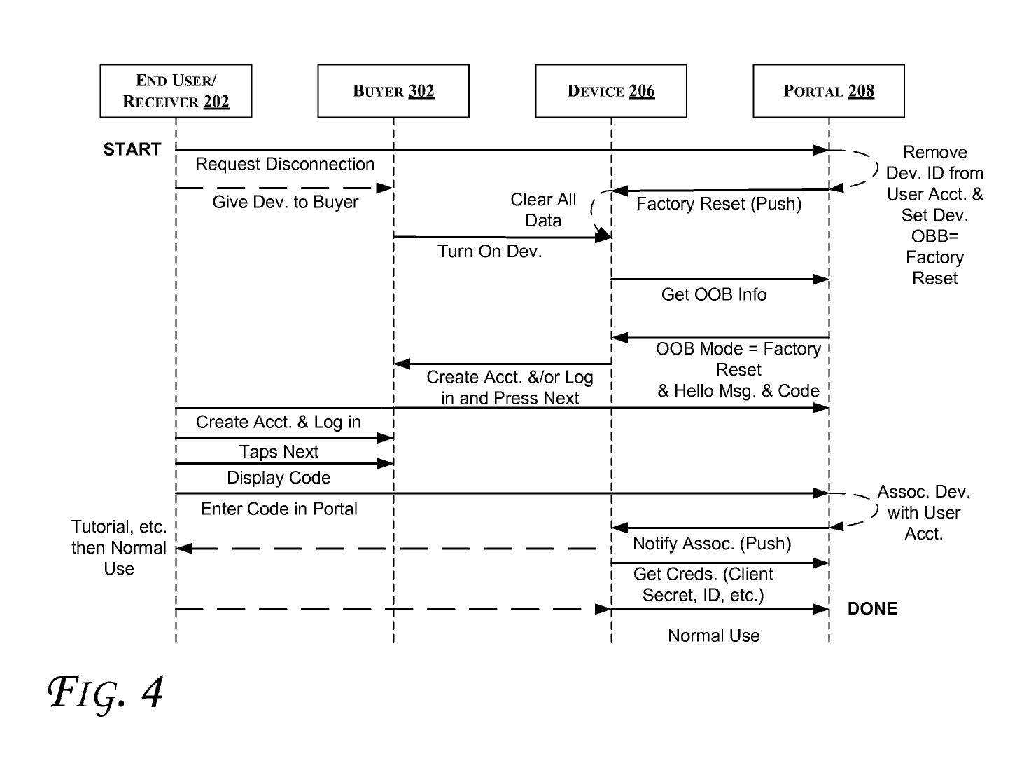

Referring to FIG. 4, the sequence for resetting a device to factory settings is shown. The sequence allows for handing off the device to another user and still keeping the original user's settings and information private. The original user clicks on an option to disconnect the device (e.g., via a web interface provided by the portal 208). The device ID is then removed from the original user's account and the device OOB mode is set to factory reset. The factory rest is pushed to the device which causes all stored data on the device (e.g., relating to the original user) to be cleared (assuming the device is on or the original user turns it on). If the device was a gift, the user may return it to the buyer who then turns the device on. As illustrated in FIG. 4, the next sequences assume the device was a gift and communicate information to/from the buyer. However, if the device was purchased by the user, the next sequences are reported to or performed by the user instead. Once the device is on, it obtains the OOB information from the portal and the portal indicates the OOB mode setting, e.g., with a generic message and code. The device then indicates that an account needs to be created and/or a login is required to proceed to the next step. The account creation and/or login is then performed via the portal (and any further confirmations are done, such as taping next, the device displaying code, the user/buyer entering the code in the portal, etc.). After the code is entered in the portal, the device is associated with a different account than the original user's (e.g., the buyer's account or the next user's account). The association between the account and device is then created (e.g., pushed to the device). The buyer/user then receives information (e.g., regarding a personalized tutorial, etc.). Next, various authentication operations may be done (such as exchange of credential information, client/device secret keys, biometric information (voice, pulse fingerprint, etc.) IDs, etc.). The buyer or next user then starts normal use of the device.

Accordingly, in some embodiments, a user may purchase a new device (e.g., through a web site), and while doing so a new account is created. The purchase kicks off a behind-the-scenes process that connects unique device information (from fulfillment and manufacturing) to the newly created user account. When the user receives the device, either in store or via mail, the device “calls home” (to the portal 208) over a wireless connection (such as a cellular network) with unique device information. In response to the “call home”, a personalized user experience is presented to the user, and, after authentication the device automatically acquires the user's configuration settings from a web service (i.e., portal 208) based on the previously created account. This approach provides a highly personalized and automated setup process to increase ease of use and emotional connection. In addition, some embodiments allow for giving devices as gifts.

By contrast, some implementations may need the user to manually enter many configuration settings after they have already purchased/acquired the device, download mobile phone companion applications from application stores, and/or input information using limited input functions (e.g., tiny keyboards or button schemes). Also, wearable devices are often paired with a phone via Bluetooth™ (or connecting with WiFi (Wireless Fidelity)) which can be frustrating and non-uniform depending on the device's operation system and version.

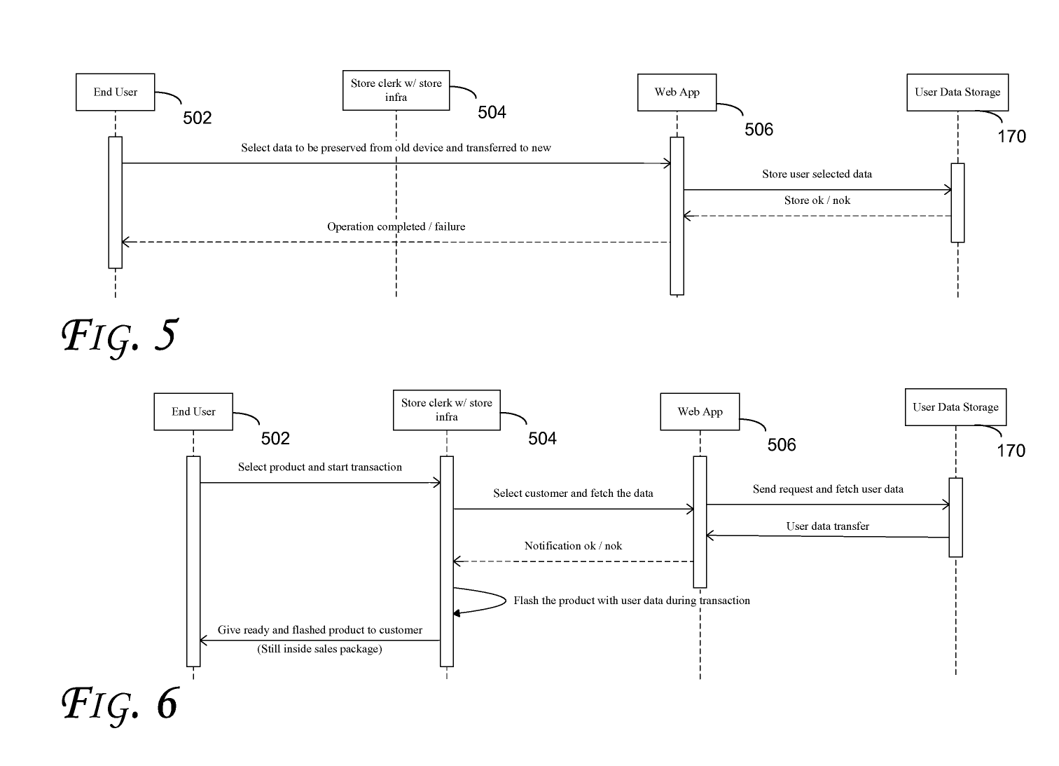

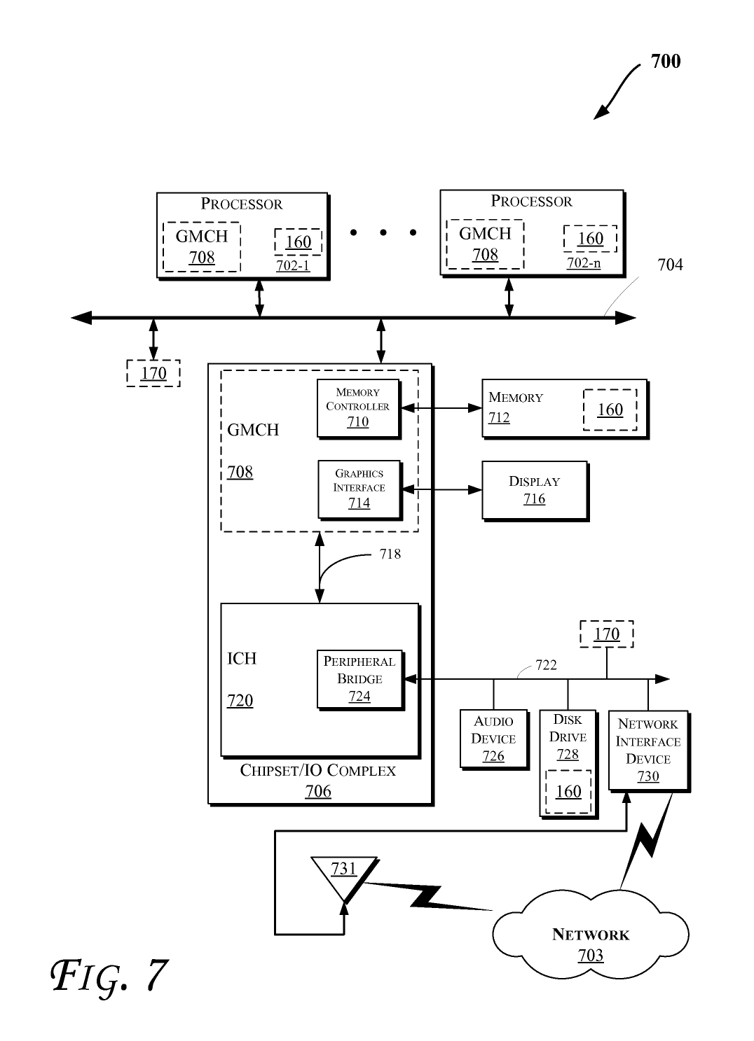

FIGS. 5-6 illustrate sequence diagrams describing flows for a mobile device before purchase decision (e.g., either at home via a web site or at a store infrastructure) and during purchase transaction at store (whether a brick and mortar store or a web store), respectively, according to some embodiments. One or more components discussed herein (e.g., with reference to FIGS. 1 and 7-9) may be used to perform one or more operations discussed with reference to FIGS. 5-6. For example, logic 160 may be used to perform the operations discussed with reference to FIGS. 5-6 at the device and/or NVM 170 may be used to store information (such as user data, unique identifier(s), authentication data, IDs, credentials, client/device secret keys, etc.). Also, the arrows in FIGS. 5-6 illustrate the data/operation flow direction (with the corresponding text appearing above the arrows, with the exception of the curved arrow in FIG. 6 that has its corresponding text next to the arrow).

More specifically, the sequence flow of FIGS. 5 and/or 6 ensure that a device is ready for normal operation right after unboxing. Referring to FIG. 5, end user 502 selects via a provided service (such as a web application 506) those data and information from an old device the user wants to have available in new device (e.g., stored in NVM 170). The user data storage then indicates whether the store operation is okay or not okay (NOK). The web application 506 then indicates to the user 502 whether the operation was completed or failed.

Referring to FIG. 6, end user 502 goes to a store 504 to purchase the new device and makes the transaction. At the same time, during the transaction, the same service that user used to store the data (e.g., web application 506) is used by the store to fetch the data and flash it wirelessly (e.g., via a wireless device such as device 731 of FIG. 7) into the device. After the transaction, the end user unboxes the devices and performs first boot without having to wait for synching delays.

Currently, devices require an additional step after unboxing to upload/synchronize the user desired data to the new device. This data can already be in a cloud and requires only a device registration with that account and syncing the content. Hence, some embodiments allow skipping the above step altogether, i.e., the device would be ready to use right after unboxing, e.g., already containing all the data user needs and wants. At a minimum, the device could show a welcome notice with user's name during first power-on, providing a magical ‘how this was done’ moment during un-boxing.

Also, use of non-volatile memory 170 (such as PCM) for value adding for end users is currently not done either. More specifically, most of the platform solutions available currently do not have any non-volatile memory available to enable such use cases. Coupled with a wireless interface to program the NVM provides a solution for a whole new array of use cases, such as unique and personalized unboxing or out-of-the-box experience.

Further, some embodiments are scalable from very simple implementation such as displaying user's name in ‘Hello XYZ’ type of notification (e.g., during first power-on requiring a very small amount of non-volatile memory) all the way to ensuring all user selected data is transferred prior to unboxing the mobile device. Also, wireless flashing and/or the customer services (a way for customer to select and upload data to be preserved from old device and for retailer to fetch that data and flash it into the new device), e.g., via the application 506, provide a combination that would provide a much enhanced experience for end users. Also, in order to flash the device wirelessly while inside the box might require some charge in the device's battery, and in case the battery is empty the flashing might fail. Hence, it is envisioned that a manufacturer ship the device with some amount of battery charge.

FIG. 7 illustrates a block diagram of a computing system 700 in accordance with an embodiment. The computing system 700 may include one or more central processing unit(s) (CPUs) 702 or processors that communicate via an interconnection network (or bus) 704. The processors 702 may include a general purpose processor, a network processor (that processes data communicated over a computer network 703), or other types of a processor (including a reduced instruction set computer (RISC) processor or a complex instruction set computer (CISC)).

Moreover, the processors 702 may have a single or multiple core design. The processors 702 with a multiple core design may integrate different types of processor cores on the same integrated circuit (IC) die. Also, the processors 702 with a multiple core design may be implemented as symmetrical or asymmetrical multiprocessors. In an embodiment, one or more of the processors 702 may be the same or similar to the processors 102 of FIG. 1. For example, one or more components of system 700 may include one or more of logic 160 and/or NVM 170 discussed with reference to FIGS. 1-6. Also, the operations discussed with reference to FIGS. 1-6 may be performed by one or more components of the system 700.

A chipset 706 may also communicate with the interconnection network 704. The chipset 706 may include a graphics memory control hub (GMCH) 708, which may be located in various components of system 700 (such as those shown in FIG. 7). The GMCH 708 may include a memory controller 710 that communicates with a memory 712 (which may be the same or similar to the memory 114 of FIG. 1). The memory 712 may store data, including sequences of instructions, that may be executed by the CPU 702, or any other device included in the computing system 700. In one embodiment, the memory 712 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 704, such as multiple CPUs and/or multiple system memories.

The GMCH 708 may also include a graphics interface 714 that communicates with a display device 716. In one embodiment, the graphics interface 714 may communicate with the display device 716 via an accelerated graphics port (AGP) or Peripheral Component Interconnect (PCI) (or PCI express (PCIe) interface). In an embodiment, the display 716 (such as a flat panel display) may communicate with the graphics interface 714 through, for example, a signal converter that translates a digital representation of an image stored in a storage device such as video memory or system memory into display signals that are interpreted and displayed by the display 716. The display signals produced by the display device may pass through various control devices before being interpreted by and subsequently displayed on the display 716.

A hub interface 718 may allow the GMCH 708 and an input/output control hub (ICH) 720 to communicate. The ICH 720 may provide an interface to I/O device(s) that communicate with the computing system 700. The ICH 720 may communicate with a bus 722 through a peripheral bridge (or controller) 724, such as a peripheral component interconnect (PCI) bridge, a universal serial bus (USB) controller, or other types of peripheral bridges or controllers. The bridge 724 may provide a data path between the CPU 702 and peripheral devices. Other types of topologies may be utilized. Also, multiple buses may communicate with the ICH 720, e.g., through multiple bridges or controllers. Moreover, other peripherals in communication with the ICH 720 may include, in various embodiments, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 722 may communicate with an audio device 726, one or more disk drive(s) 728, and a network interface device 730 (which is in communication with the computer network 703). As shown, the network interface device 730 may be coupled to an antenna 731 to wirelessly (e.g., via an Institute of Electrical and Electronics Engineers (IEEE) 802.11 interface (including IEEE 802.11a/b/g/n, etc.), cellular interface, 3G, 5G, LTE (Long Term Evolution), etc.) communicate with the network 703. Other devices may communicate via the bus 722. Also, various components (such as the network interface device 730) may communicate with the GMCH 708 in some embodiments. In addition, the processor 702 and the GMCH 708 may be combined to form a single chip. Furthermore, a graphics accelerator may be included within the GMCH 708 in other embodiments.

Furthermore, the computing system 700 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 728), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

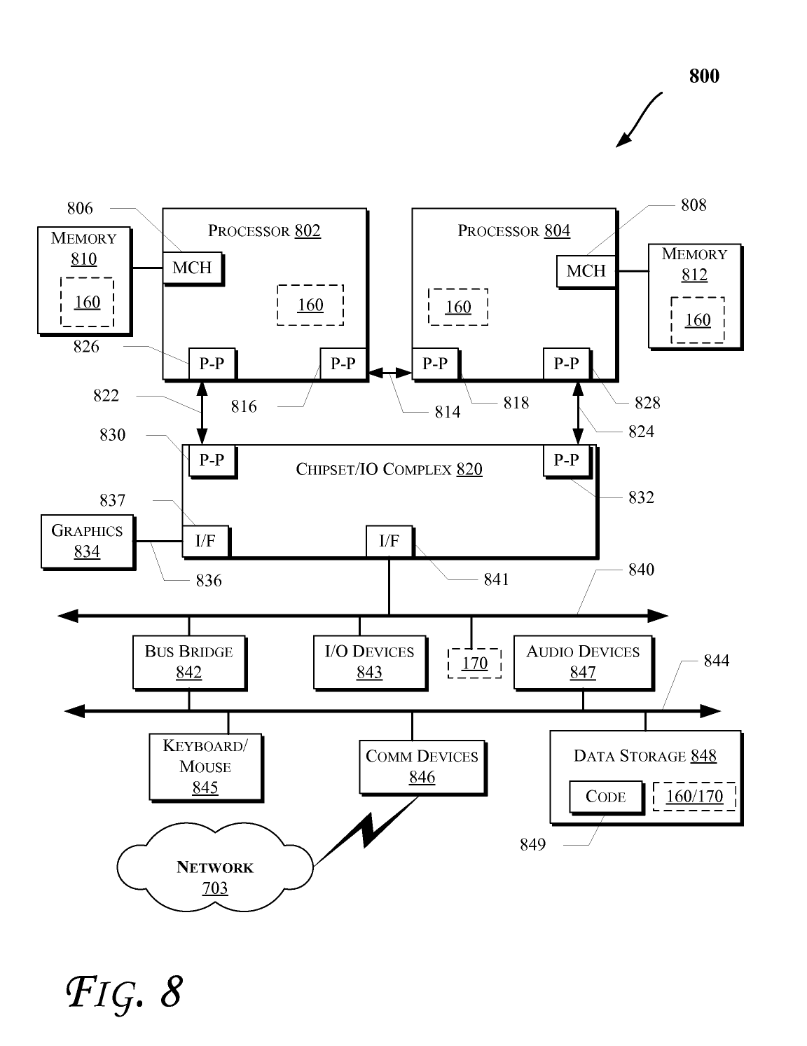

FIG. 8 illustrates a computing system 800 that is arranged in a point-to-point (PtP) configuration, according to an embodiment. In particular, FIG. 8 shows a system where processors, memory, and input/output devices are interconnected by a number of point-to-point interfaces. The operations discussed with reference to FIGS. 1-7 may be performed by one or more components of the system 800.

As illustrated in FIG. 8, the system 800 may include several processors, of which only two, processors 802 and 804 are shown for clarity. The processors 802 and 804 may each include a local memory controller hub (MCH) 806 and 808 to enable communication with memories 810 and 812. The memories 810 and/or 812 may store various data such as those discussed with reference to the memory 712 of FIG. 7.

In an embodiment, the processors 802 and 804 may be one of the processors 702 discussed with reference to FIG. 7. The processors 802 and 804 may exchange data via a point-to-point (PtP) interface 814 using PtP interface circuits 816 and 818, respectively. Also, the processors 802 and 804 may each exchange data with a chipset 820 via individual PtP interfaces 822 and 824 using point-to-point interface circuits 826, 828, 830, and 832. The chipset 820 may further exchange data with a graphics circuit 834 via a graphics interface 836, e.g., using a PtP interface circuit 837.

At least one embodiment may be provided within the processors 802 and 804. For example, one or more components of system 800 may include one or more of logic 160 and/or NVM 170 of FIGS. 1-7, including located within the processors 802 and 804. Other embodiments, however, may exist in other circuits, logic units, or devices within the system 800 of FIG. 8. Furthermore, other embodiments may be distributed throughout several circuits, logic units, or devices illustrated in FIG. 8.

The chipset 820 may communicate with a bus 840 using a PtP interface circuit 841. The bus 840 may communicate with one or more devices, such as a bus bridge 842 and I/O devices 843. Via a bus 844, the bus bridge 842 may communicate with other devices such as a keyboard/mouse 845, communication devices 846 (such as modems, network interface devices, or other communication devices that may communicate with the computer network 703), audio I/O device 847, and/or a data storage device 848. The data storage device 848 may store code 849 that may be executed by the processors 802 and/or 804.

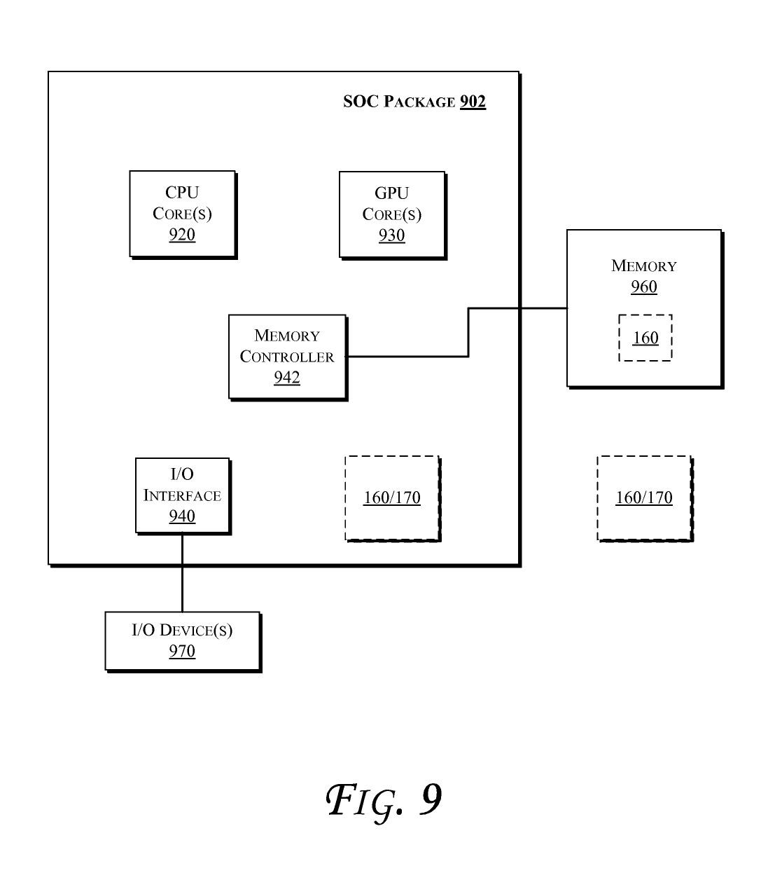

In some embodiments, one or more of the components discussed herein can be embodied as a System On Chip (SOC) device. FIG. 9 illustrates a block diagram of an SOC package in accordance with an embodiment. As illustrated in FIG. 9, SOC 902 includes one or more Central Processing Unit (CPU) cores 920, one or more Graphics Processor Unit (GPU) cores 930, an Input/Output (I/O) interface 940, and a memory controller 942. Various components of the SOC package 902 may be coupled to an interconnect or bus such as discussed herein with reference to the other figures. Also, the SOC package 902 may include more or less components, such as those discussed herein with reference to the other figures. Further, each component of the SOC package 920 may include one or more other components, e.g., as discussed with reference to the other figures herein. In one embodiment, SOC package 902 (and its components) is provided on one or more Integrated Circuit (IC) die, e.g., which are packaged into a single semiconductor device.

As illustrated in FIG. 9, SOC package 902 is coupled to a memory 960 (which may be similar to or the same as memory discussed herein with reference to the other figures) via the memory controller 942. In an embodiment, the memory 960 (or a portion of it) can be integrated on the SOC package 902.

The I/O interface 940 may be coupled to one or more I/O devices 970, e.g., via an interconnect and/or bus such as discussed herein with reference to other figures. I/O device(s) 970 may include one or more of a keyboard, a mouse, a touchpad, a display, an image/video capture device (such as a camera or camcorder/video recorder), a touch screen, a speaker, or the like. Furthermore, SOC package 902 may include/integrate the logic 160 and/or NVM 170 in an embodiment. Alternatively, the logic 160 and/or NVM 170 may be provided outside of the SOC package 902 (i.e., as a discrete components/logic).

The following examples pertain to further embodiments. Example 1 includes an apparatus comprising: logic, the logic at least partially comprising hardware logic, to cause receipt of user information at a device, which includes the logic, from a web portal in response to powering up the device, wherein the logic is to cause creation of an account at the web portal for an end user in response to receipt of the user information and a code from the web portal at the logic, wherein the logic is to cause display of the code to the end user to cause the device to become associated with the account in response to receipt of the code from the end user at the web portal. Example 2 includes the apparatus of example 1, further comprising a wireless network interface device to provide a communication channel between the device and the web portal. Example 3 includes the apparatus of example 2, wherein the wireless network interface device is to comprise a cellular interface. Example 4 includes the apparatus of example 1, wherein the device is to exchange authentication information with the web portal before granting normal operational access to the end user to use the device. Example 5 includes the apparatus of example 1, wherein the device is to comprise a mobile computing device. Example 6 includes the apparatus of example 5, wherein the mobile computing device is to comprise one of: a smartphone, a tablet, a UMPC (Ultra-Mobile Personal Computer), a laptop computer, an Ultrabook™ computing device, a smart watch, smart glasses, or a wearable device with limited input capability. Example 7 includes the apparatus of example 1, wherein the user information is personalized user information associated with the end user to provide an out of box personalized user experience. Example 8 includes the apparatus of example 1, further comprising memory to store one or more of: the user information and the code. Example 9 includes the apparatus of example 1, wherein one or more of the logic, memory, or a processor, having one or more processor cores, are on a single integrated circuit die.

Example 10 includes an apparatus comprising: non-volatile memory to store user data that is selected via a web application to be transferred from a first device to a second device, wherein the second device is to include the non-volatile memory; and logic, the logic at least partially comprising hardware logic, to cause storage of the user data in the non-volatile memory in response to an indication that the second device has been purchased. Example 11 includes the apparatus of example 10, wherein the logic is to cause storage of the user data in the non-volatile memory prior to unboxing the second device. Example 12 includes the apparatus of example 10, further comprising a wireless network interface device to provide a communication channel between the second device and the web application. Example 13 includes the apparatus of example 10, wherein one or more of the logic, memory, or a processor, having one or more processor cores, are on a single integrated circuit die. Example 14 includes the apparatus of example 10, wherein the non-volatile memory is to comprise one or more of resistive random access memory, Phase Change Memory (PCM), Spin Torque Transfer Random Access Memory (STTRAM), or 3D (3-Dimensional) Cross Point Memory. Example 15 includes the apparatus of example 10, further comprising a battery to power the device.

Example 16 includes a computer-readable medium comprising one or more instructions that when executed on a processor configure the processor to perform one or more operations to: cause receipt of user information at a device from a web portal in response to powering up the device, wherein an account is created at the web portal for an end user in response to receipt of the user information and a code from the web portal at the device, wherein the device causes display of the code to the end user to cause the device to become associated with the account in response to receipt of the code from the end user at the web portal. Example 17 includes the computer-readable medium of example 16, further comprising one or more instructions that when executed on the processor configure the processor to perform one or more operations to provide a wireless communication channel between the device and the web portal. Example 18 includes the computer-readable medium of example 16, further comprising one or more instructions that when executed on the processor configure the processor to perform one or more operations to cause the device to exchange authentication information with the web portal before granting normal operational access to the end user to use the device. Example 19 includes the computer-readable medium of example 16, wherein the device is to comprise a mobile computing device. Example 20 includes the computer-readable medium of example 19, wherein the mobile computing device is to comprise one of: a smartphone, a tablet, a UMPC (Ultra-Mobile Personal Computer), a laptop computer, an Ultrabook™ computing device, a smart watch, smart glasses, or a wearable device with limited input capability. Example 21 includes the computer-readable medium of example 16, wherein the user information is personalized user information associated with the end user to provide an out of box personalized user experience.

Example 22 includes a computer-readable medium comprising one or more instructions that when executed on a processor configure the processor to perform one or more operations to: store user data in non-volatile memory, the user data to be selected via a web application to be transferred from a first device to a second device, wherein the second device includes the non-volatile memory; and cause storage of the user data in the non-volatile memory in response to an indication that the second device has been purchased. Example 23 includes the computer-readable medium of example 22, further comprising one or more instructions that when executed on the processor configure the processor to perform one or more operations to cause storage of the user data in the non-volatile memory prior to unboxing the second device. Example 24 includes the computer-readable medium of example 22, further comprising one or more instructions that when executed on the processor configure the processor to perform one or more operations to provide a communication channel between the second device and the web application. Example 25 includes the computer-readable medium of example 22, wherein the non-volatile memory is to comprise one or more of resistive random access memory, Phase Change Memory (PCM), Spin Torque Transfer Random Access Memory (STTRAM), or 3D (3-Dimensional) Cross Point Memory.

Example 26 includes a method comprising: causing receipt of user information at a device from a web portal in response to powering up the device, wherein an account is created at the web portal for an end user in response to receipt of the user information and a code from the web portal at the device, wherein the device causes display of the code to the end user to cause the device to become associated with the account in response to receipt of the code from the end user at the web portal. Example 27 includes the method of example 26, further comprising one or more instructions that when executed on the processor configure the processor to perform one or more operations to provide a wireless communication channel between the device and the web portal. Example 28 includes the method of example 26, further comprising one or more instructions that when executed on the processor configure the processor to perform one or more operations to cause the device to exchange authentication information with the web portal before granting normal operational access to the end user to use the device. Example 29 includes the method of example 26, wherein the device is to comprise a mobile computing device. Example 30 includes the method of example 29, wherein the mobile computing device is to comprise one of: a smartphone, a tablet, a UMPC (Ultra-Mobile Personal Computer), a laptop computer, an Ultrabook™ computing device, a smart watch, smart glasses, or a wearable device with limited input capability. Example 31 includes the method of example 26, wherein the user information is personalized user information associated with the end user to provide an out of box personalized user experience.

Example 32 includes a method comprising: storing user data in non-volatile memory, the user data to be selected via a web application to be transferred from a first device to a second device, wherein the second device includes the non-volatile memory; and cause storage of the user data in the non-volatile memory in response to an indication that the second device has been purchased. Example 33 includes the method of example 32, further comprising one or more instructions that when executed on the processor configure the processor to perform one or more operations to cause storage of the user data in the non-volatile memory prior to unboxing the second device. Example 34 includes the method of example 32, further comprising one or more instructions that when executed on the processor configure the processor to perform one or more operations to provide a communication channel between the second device and the web application. Example 35 includes the method of example 32, wherein the non-volatile memory is to comprise one or more of resistive random access memory, Phase Change Memory (PCM), Spin Torque Transfer Random Access Memory (STTRAM), or 3D (3-Dimensional) Cross Point Memory.

Example 36 includes an apparatus comprising means to perform a method as set forth in any preceding example.

Example 37 includes a machine-readable storage including machine-readable instructions, when executed, to implement a method or realize an apparatus as set forth in any preceding example.

Example 38 includes a computer-readable medium comprising one or more instructions that when executed on a processor configure the processor to perform one or more operations of any of examples 26 to 35.

Example 39 includes an apparatus comprising means to perform a method as set forth in any of examples 26 to 35.

In various embodiments, the operations discussed herein, e.g., with reference to FIGS. 1-9, may be implemented as hardware (e.g., logic circuitry), software, firmware, or combinations thereof, which may be provided as a computer program product, e.g., including a tangible (e.g., non-transitory) machine-readable or computer-readable medium having stored thereon instructions (or software procedures) used to program a computer to perform a process discussed herein. The machine-readable medium may include a storage device such as those discussed with respect to FIGS. 1-9.

Additionally, such computer-readable media may be downloaded as a computer program product, wherein the program may be transferred from a remote computer (e.g., a server) to a requesting computer (e.g., a client) by way of data signals provided in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1. (canceled)

2. (canceled)

3. (canceled)

4. (canceled)

5. (canceled)

6. (canceled)

7. (canceled)

8. (canceled)

9. (canceled)

10. An apparatus comprising:
non-volatile memory to store user data that is selected via a web application to be transferred from a first device to a second device, wherein the second device is to include the non-volatile memory; and
logic, the logic at least partially comprising hardware logic, to cause storage of the user data in the non-volatile memory in response to an indication that the second device has been purchased.

11. The apparatus of claim 10, wherein the logic is to cause storage of the user data in the non-volatile memory prior to unboxing the second device.

12. The apparatus of claim 10, further comprising a wireless network interface device to provide a communication channel between the second device and the web application.

13. The apparatus of claim 10, wherein one or more of the logic, memory, or a processor, having one or more processor cores, are on a single integrated circuit die.

14. The apparatus of claim 10, wherein the non-volatile memory is to comprise one or more of resistive random access memory, Phase Change Memory (PCM), Spin Torque Transfer Random Access Memory (STTRAM), or 3D (3-Dimensional) Cross Point Memory.

15. The apparatus of claim 10, further comprising a battery to power the device.

16. (canceled)

17. (canceled)

18. (canceled)

19. (canceled)

20. (canceled)

21. (canceled)

22. A computer-readable medium comprising one or more instructions that when executed on a processor configure the processor to perform one or more operations to:
store user data in non-volatile memory, the user data to be selected via a web application to be transferred from a first device to a second device, wherein the second device includes the non-volatile memory; and
cause storage of the user data in the non-volatile memory in response to an indication that the second device has been purchased.

23. The computer-readable medium of claim 22, further comprising one or more instructions that when executed on the processor configure the processor to perform one or more operations to cause storage of the user data in the non-volatile memory prior to unboxing the second device.

24. The computer-readable medium of claim 22, further comprising one or more instructions that when executed on the processor configure the processor to perform one or more operations to provide a communication channel between the second device and the web application.

25. The computer-readable medium of claim 22, wherein the non-volatile memory is to comprise one or more of resistive random access memory, Phase Change Memory (PCM), Spin Torque Transfer Random Access Memory (STTRAM), or 3D (3-Dimensional) Cross Point Memory.
